(19) United States
(12) Patent Application Publication
(10) Pub. No.: US 2020/0391818 A1
(43) Pub. Date: Dec. 17, 2020

(54) FOLDING BICYCLE WITH FOLDING HANDLEBAR, WHEELS AND FRAME, COMPRISING AN INTEGRATED STRUCTURE PROVIDING A MINIMUM FOLDED CONFIGURATION

(71) Applicant: Rafael Alejandro ALONSO ALVAREZ, Ciudad de México (MX)

(72) Inventor: Rafael Alejandro ALONSO ALVAREZ, Ciudad de México (MX)

(21) Appl. No.: 16/766,733

(22) PCT Filed: Nov. 27, 2018
(86) PCT No.: PCT/MX2018/000125

§ 371 Date: May 25, 2020

(30) Foreign Application Priority Data
Nov. 28, 2017 (MX) MX/A/2017//015313

(51) Int. Cl. B62K 15/00; B60B 1/00; B60B 19/04; B60B 25/02

(52) U.S. Cl. CPC B62K 15/008; B60B 25/02; B60B 19/04; B60B 1/003

(57) ABSTRACT

The present invention relates to a folding bicycle comprising a plurality of folding elements which are grouped together into main elements, such as the frame (3), the handlebar (1), the front wheel (25), and the rear wheel (24), said main elements being combined to form one inseparable element.

The plurality of folding elements that are grouped together to form main elements allow the folding bicycle of the present invention to be carried in a so-called folded state or configuration in which it occupies a minimum volume. The folded configuration allows the bicycle to be easily transported or packed inside a standard backpack.

In the so-called unfolded or maximum-size configuration, the folding bicycle of the present invention can be cycled comfortably and safely like any standard size bicycle. The integrity of all of the components or elements of the folding bicycle of the present invention is maintained in both the folded and unfolded configurations, as well as when switching between the two configurations, meaning that there are no loose pieces and that all of the constituent elements are permanently attached to one another. The process for switching between the folded and unfolded configurations, or vice versa, is simple and does not require any external elements or additional tools, and can be carried out by the user alone following simple steps.

### INVENTION FIELD OF THE INVENTION

This invention its related with the personal transport filed, specificity in the folding bicycle modality.

### INVENTION TARGET

A personal transport system which presents the best relation between maximum unfolding volume and minimum folding area; allowing the user a safety and comfortable transportation when its unfold, and a minimum storage space in its fold configuration thanks to ability to the bicycle to have a smaller area that the unfold wheel, allowing store the bicycle in its fold configuration in a standard backpack.

This is achieved thanks to the fact that all the element in the bicycle are foldable, including the frame (3). The handlebar (2) and the front wheel (25) and rear wheel (24).

### BACKGROUND

The folding bicycles started at the end of the 1800's due the interest of the European armies to provide the soldiers with the ability of increase their mobility with an autonomous mobility device which they can carry in their bags when it was not in use.

During the first part of the XX century the arm conflicts like the first and second world war allowed the develop of the first folding bicycles, reducing their sizes and folding thanks to the advances in production methods and materials.

However the growth in the folding bicycles market skyrocketed in the 80's, in part to the emergence of brands like Dahon and Brompton, thanks to their designs and market strategies which accomplished that the bicycle became a common transport device.

Today in the second decade of the XX century the folding bicycles are become an essential device of personal transportation due to the automobile routes saturation and also as a measure to fight the climate change caused by the internal combustion engine.

From the information collected for the state of the art, it can be define the types of folding bicycles and folding methods in the following categories.

Middle Folding

Currently the folding bicycles are conceived from the beginning to be folding bicycles, that why the dimensions are minimized and they adapt the folding components in relation to the common bicycles, that's why the folding bicycles usually are smaller that the ordinary bicycles in the frame wheels and other components.

The middle folding bicycles works by tacking a regular bicycle and adapt a folding mechanism which allows reducing the dimensions in half in their folding state.

Usually the folding system it's a hinge in the middle of the frame allowing rotate half of the frame approximately 180° achieving reducing the dimension of the frame by half in the sagittal plane (35) placing the back and front wheel side by side.

Vertical Folding:

This method it's very similar to the middle folding system, using a hinge in the frame central axis, adapting the design components, wheel diameter and the possibility of folding the handlebar with the use of a hinge to align it with the tow folded frame halves.

Triangular Hinge:

This folding method combine the hinges axis in the frame of the previous methods in a vertical axis (39), to a cross axis (40), allowing by tow hinges in the frame (unlike a single hinge in the previous methods) creates a triangle shape. As well as the previous methods the wheels end up side to side. Equally as most designs that use this method it is possible to folding the handlebar on one side of the wheel

This bicycle frame folding configuration allows the frame shortening when is fold, on a scale with regard to the vertical folding, achieving in some cases that the frame dimensions when it is fold will be similar or even smaller to the wheel diameter.

Detached

This type of folding bicycle do not really fold itself. This type of bicycle strategy as the name suggest is detach the components on individual prizes for later storage in some kind of backpack or container.

When the user intends to use the bicycle as a transport device, it have to assemble the bicycle using all the detached components, repeating the cycle again and again. The clear disadvantage it is that the user can lose some detach component, which make impossible assemble the bicycle until the component is replace.

During the assembly and disassembly of this kind of bicycle it often requires external specialized tools like spanners or screwdrivers which requires special storage for the detach components like the folding bicycle “Gocycle”, which comes with some kind of case with the shape of the bicycle detached.

Mixed:

The previous methods are the most known and used in the folding bicycle design. Some folding bicycles use different elements to solve particular problems, or take the best of each one creating more favorable combinations, this ones are known as mixed.

For instance a vertical folding frame bicycle where the wheels are detached, which have to be stored in special containers.

The current folding bicycles allowed folding the frame, handlebar, pedals, and other components on very small dimensions. However the physical limit to achieve the minimal folding size. However the physical limit to reach the minimal folding dimension it's the diameter of the wheel.

Considering all that it's not possible folding a bicycle on small area that the diameter of the wheel.

The folding strategies mentioned before use different approaches considering the wheel diameter to get the smallest folding area using the following methods:

Regular Wheels:

Regular or conventional wheels have a similar structure to the not foldable bicycles, with the only difference that they have a smaller diameter, keeping structural elements, valve or some kind of damping method, keeping the compromise of a diameter of no less of 40 cm (15.748 in).

The advantage of this kind of wheel it's that gives the uses a comfortable and safety ride thanks to the damping surface.

The disadvantage it's that despite it reduces the diameter of the wheel still it's a considerable diameter for folding.

Trolley Wheels Type:

As the name suggest some folding bicycles dramatically reduce its folding area by using extraordinary small wheel (something between 10 to 20 cm/3.93 to 7.87 in), similar to the ones used in supermarket trolleys or scooters.

This configuration allows a smaller folding area as before due the reduce diameter of the wheel. One of the most known examples of this type of bike is the “A-bike”.

As well the reduce diameter of the wheel decrease the stability, making harder to the user keep balance and riding the bicycle, also make him more vulnerable to and imperfection in the road and obstacles like bumps, sidewalk, stones and twigs, increasing the possibility to have an accident.

This kind of wheel are in most cases solid (no air chamber) reducing drastically the ride comfort for its inability of absorbing vibrations and road obstacles.

Finally due the reduce diameter in this kind of wheel the pedaling wheel revolution ratio will be considerably lower than regular size wheels, requiring a harder pedaling to achieve the required speed, getting tired the user, especially uphill.

Detached Wheels:

The strategy of this kind of bicycles it's detached completely the wheels from the frame when it is folded. Usually the detachment of the wheel allows the frame to fold and then storage each one independently.

In this type of wheel varieties the shape and the dimensions include but not limited to, regular wheels (16 in), trolley wheels, folding wheels or toroid wheels with no central axis.

The fact that the wheel can be detached of the frame allow use different type of wheels due to when the wheel is detached do not have to coexist with the fold frame.

Likewise the detached bicycles biggest disadvantage is the possibility of losing the components due to the separation in the fold stage.

It is now the state of the art folding bicycles with folding wheels (CN 202243869), which they have a smaller configuration in its fold state where its folding rotation in the cross plane with at least two folding axis. This folding bicycles have their elements detaches during the folding and unfolding process, focusing its target of less fold area possible, assuming the risk of losing parts.

There are also folding bicycles with several folding elements like the frame, the handlebar without keeping their own integrity as a single unit (CN 202243869).

The folding system of the bicycle (CN 202243869) it's achieved by a number of axis and planes which manage to have minor configuration in which one or more elements mainly the tyres detach in its minimum configuration. This implies (the inherent issues to the detached elements) the detached element can be lose and with that not having the integrity of the bicycle making it impossible to use.

In the example documents; CN 202243869, CN1105053C and U.S. Pat. No. 6,702,312B1 the distance between pedals and the traction axis in the rear wheel always keep the same distance in the fold and unfold state

In the state of the art are mentioned some patent applications in which its described folding bicycles where the folding limit it is the wheel diameter, mainly U.S. Pat. No. 6,702,312B1 and CN 20235827 U present a minimal configuration in which use standard wheels without folding system.

Also exist folding bicycles which have developed folding wheels like the application CN1105053C in which the frame and the wheels are foldable reaching both a minimal configuration, however are detachable losing its integrity with the problems mentioned before.

The addition of a folding wheel known in the state of the art like example CN101678707B, do not reduce proportionally in its sagittal axis so when reduces its area in the back axis, increases the area in the vertical axis.

There are other examples like CN 102991267B in which reduces it proportional area at the expense of increase significantly its area in the cross axis preventing keeping the wheel attached to the frame in its folding state.

Finally are known detachable wheels sectioned like it's described in CN 202243869 U, in which are united in the center stacking the segments in the center axis creating a bigger volume in one side. Another inconvenience happened when keep the perpendicular segments in the wheel arm. Which creates a smaller volume in the wheel in its folding state.

### BRIEF DESCRIPTION OF THE FIGURES

Will be described the attached figures.

FIG. 1 Invention lateral view in it's unfold state.

FIG. 2 Invention lateral view in its fold state.

FIG. 3 Front wheel (25) lateral view in its unfold state.

FIG. 4 Perspective of the wheel in its fold state.

FIG. 5 Perspective of the invention in it's unfold state (top drawing) and fold state (below drawing) in the sagittal axis (35). In this drawing it shows the relation between widths in its fold and unfold state.

FIG. 6 perspective of the invention in its unfold state (left drawing) and fold state (right drawing) comparing height, using as a base the floor in dotted line.

FIG. 7 Invention top full view, comparing the unfold state (left drawing) and fold state (right drawing).

FIG. 8 Invention frame (3) lateral view, showing the displacement of the rear fork (19) in it's unfold state (left continuous line), to its fold state (continuous right line), with an intermediate middle state as an example (center dotted line).

FIG. 9 Invention lateral view in this unfold state showing in continuous line the sections conformed by the rear wheel (24) and the front wheel (25).

FIG. 10 Invention lateral view in its unfold state showing in continuous line the frame section (3).

FIG. 11 Invention lateral view in its unfold state showing in continuous line the handlebar section (1).

FIG. 12 Frame (3) components lateral view and rear wheel (24) in its unfold state, pointing the maximum distance (33) between the rear belt-drive (20) and the front belt-drive (22).

FIG. 13 Invention lateral view in its folding state, pointing the minimal distance (34) between the rear belt-drive (20) and the front belt-drive (22).

FIG. 14 Invention lateral view in it's unfold state highlighting in dotted line the displacement of the seat (16) for the fold and unfold process.

FIG. 15 Bottom bracket (13) upper perspective and the seat post (15), the bottom joint of the seat post (14), to the bottom joint of the lower extensible post (12) and the extensible down tube (11).

FIG. 16 Range movement perspective of the wheel articulated arm (30) of the wheel arch segment (27) (a)

FIG. 17 Perspective of the displacement of the wheel arch segment (27) (a).

FIG. 18 Perspective of the rotation of the wheel arch segment (27) (a).

FIG. 18 Perspective of the rotation of the wheel arch segment (27) (a).

FIG. 20 Perspective of the rotation range of the wheel toroid (26) of the wheel arch segment (27) (b, c, d).

FIG. 21 Perspective of the relation of the wheel toroid (26) wheel arch segment (27) (b, c, d).

FIG. 22 Perspective of the movement range of the wheel articulated arm (30) of the wheel arch segment (27) (b).

FIG. 23 Perspective of the displacement of the wheel arch segment (27) (b).

FIG. 24 Perspective of the range rotation of the wheel arch segment (27) (b).

FIG. 25 Perspective of the rotation of the wheel arch segment (27) (b).

FIG. 26 Perspective of the rotation range of the wheel toroid (26) of the wheel arch segment (27) (c, d).

FIG. 27 Perspective of the rotation of the wheel toroid (26) wheel arch segment (27) (c, d).

FIG. 28 Perspective of the rotation range of the wheel arch segment (27) (c).

FIG. 29 Perspective of the rotation of the wheel arch segment (27) (c)

FIG. 30 Perspective of the movement range of the wheel articulated arm (30) of the wheel arch segment (27) (d).

FIG. 31 Displacement perspective of the wheel arch segment (27) (d).

FIG. 32 Rotation range perspective of the wheel toroid (26) of the wheel arch segment (27) (d).

FIG. 33 Rotation perspective of the wheel toroid (26) of the wheel arch segment (27) (d).

FIG. 34. Range rotation perspective of the wheel arch segment (27) (d).

FIG. 35 Rotation perspective of the wheel arch segment (27) (d).

FIG. 36 Rotation range perspective of the wheel arch segment (27) (a, b, c, d).

FIG. 37 Rotation perspective of the wheel arch segment (27) (a, b, c, d).

FIG. 38 Perspective of the front wheel (25) in its folding state.

FIG. 39 Side view of the front wheel (25) in its folding state.

FIG. 40 Movement range perspective of the wheel arch segment (27).

FIG. 41 Movement perspective of the wheel arch segment (27).

FIG. 42 Perspective of the movement of the handlebar (1).

FIG. 43 Perspective of the rear wheel (24) in its fold state.

FIG. 44 Side view of the invention with the fold wheels.

FIG. 45 Side view of the folding displacement of the back fork (19).

FIG. 46 Side view of the displacement range of the saddle (16).

FIG. 47 Side view of the displacement of the saddle (16) in folding process.

FIG. 48 Rotation range perspective of the handlebar (2).

FIG. 49 Rotation perspective of the handlebar (2) folding.

FIG. 50 Retract range perspective of the handlebar extension system (5).

FIG. 51 Retraction perspective of the handlebar extension system (5).

FIG. 52 Rotation range perspective of the handlebar system (1)

FIG. 53 Rotation perspective of the handlebar system (1).

FIG. 54 Rotation range side view of the extensible down tube (11).

FIG. 55 Retraction side view of the extensible down tube (11).

FIG. 56 Rotation range side view of the top articulation of the extensible down tube (10).

FIG. 57 Rotation side view of the top articulation of the extensible down tube (10).

FIG. 58 Rotation range side view of the bottom joint of the lower extensible post (12).

FIG. 59 Rotation side view of the bottom joint of the lower extensible post (12).

FIG. 60 Sagittal plane (35), of the unfold invention.

FIG. 61 Sagittal plane (35), of the fold invention.

FIG. 62 Front plane (36), of the unfold invention.

FIG. 63 Front plane (36), of the fold invention.

FIG. 64 Crossplane (37), of the unfold invention.

FIG. 65 Crossplane (37), of the fold invention.

FIG. 66 Anteroposterior axis (38), of the unfold invention.

FIG. 67 Anteroposterior axis (38), of the fold invention.

FIG. 68 Vertical axis (39), of the fold invention.

FIG. 69 Vertical axis (39), of the fold invention.

FIG. 70 Cross axis (40), with the unfold invention.

FIG. 71 cross axis (40), of the fold invention.

FIG. 72 Side view of the wheel toroid (26).

FIG. 73 Detailed view of the node (41).

FIG. 74 Side view of the steering axis (44) with regard to the handlebar axis (45).

FIG. 75 Exploded view of the wheel axis (31).

FIG. 76 Rotation perspective of the wheel spin.

FIG. 77 Rotation perspective of the wheel axis node (31).

FIG. 78 Back view of the displacement range of the wheel arch segment (27), due to the action of the double articulation of the wheel articulated arm (30).

FIG. 79 Bottom perspective view of the front belt-drive lock (43), in is unfold state.

FIG. 80 Bottom perspective view of the front belt-drive lock (43), in its fold state.

FIG. 81 Back perspective of the rear belt-drivelock (42), in it's unfold state.

FIG. 82 Perspective of the rear belt-drivelock (42), in its fold state.

FIG. 83 Side view of the bicycle in it's unfold state (47) and the bicycle fold state (48), in comparison with a human scale (46).

### INVENTION DESCRIPTION

The word bicycle, invention bicycle, invention o other word referring to the bicycle filing application, it is used in an indistinct way and it is referred to folding bicycle object to the invention claim in this document.

The word state or configuration it is referring to the realization or conclude stages of the folding bicycle of this document, where the words “state” or “configuration” can be use indistinctly denote either its unfold and fold state.

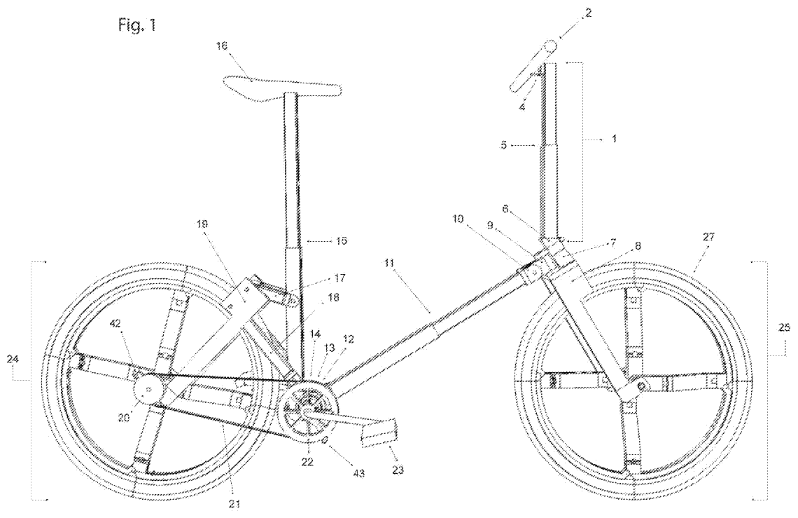

This bicycle presents two forms configuration or states, a maximum denominated “Unfold” as it shows in the FIG. 1, in which all the components in the frame (3), the handlebar system (1), the front wheel (25) and the rear wheel (24) are deployed being the optimal state to be used as a transport device.

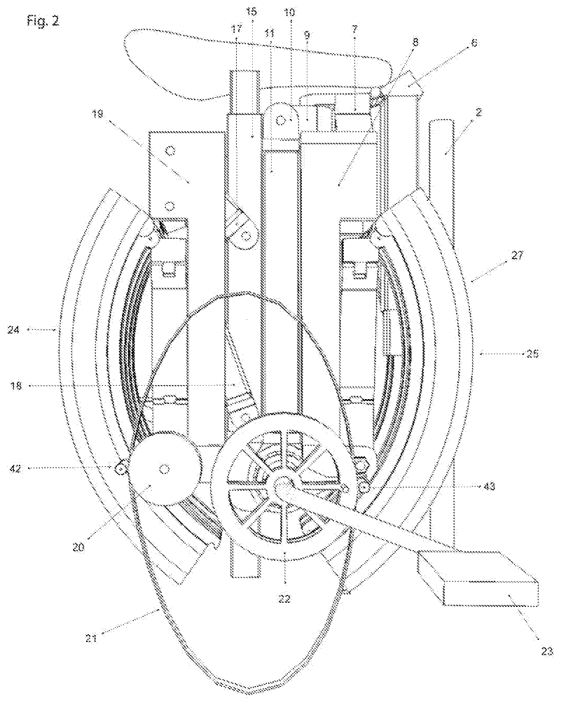

A second configuration or state its denominated “Fold” FIG. 2, in which all the components in the frame (3), the handlebar system (1), the front wheel (25) and the rear wheel (24) are compacted being the optimal state to storage.

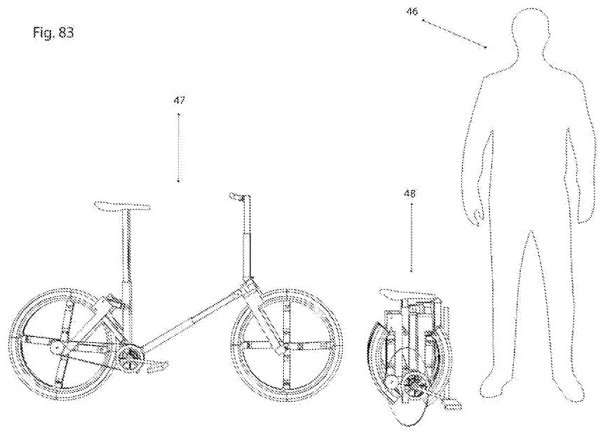

Either states or configurations are described in the FIG. 83, in which its shows the relationship between both configurations, with a human scale.

In the FIG. 83 its showed the bicycle in the bicycle in its unfold state (47) with regard to the folding relationship to the bicycle fold state (48) and both in relation to the human scale (46). Notice that the bicycle in its unfold state (47) it is safe and comfortable; in the meantime the bicycle fold state (48)) it is optimal to storage. Also it showed a 170 cm (5.57 ft.) average human scale, being used as an example model for this document, not limit itself.

The folding systems of the frame (3), the rear wheel (24), front wheel (25) and the handlebar system (1) of this invention allows when its fold all the systems are aligned vertically side by side in the sagittal plane (35), as it is shown in the FIG. 2. All that allow the dimensions in the sagittal plane (35), being smallest to the diameter of the wheel when its unfold FIG. 5.

Additionally in the FIG. 5, it showed the relationship in the sagittal plane (35) between the unfolded state (up draw) and the fold state (below draw). In this figure it's shown that when the invention it's in it fold state is less wide that the wheel in its unfold state. This area relation it is possible thanks to the folding actions of the rear wheel (24), the front wheel (25), the frame (3) and the handlebar system

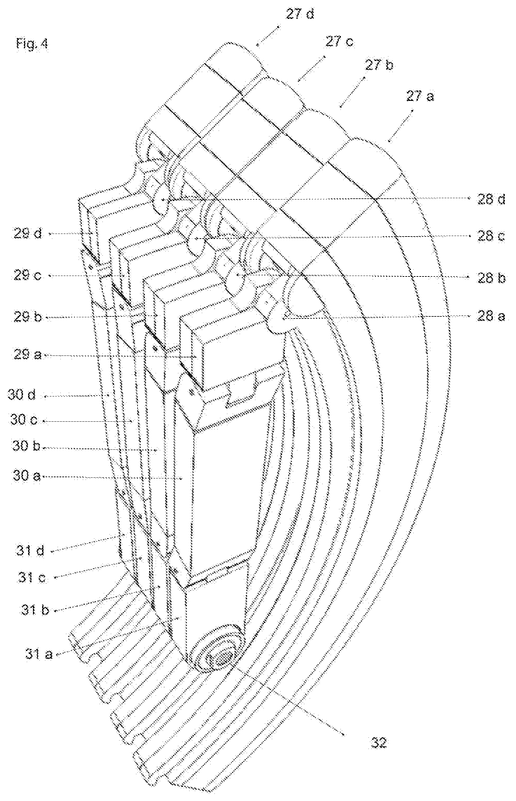

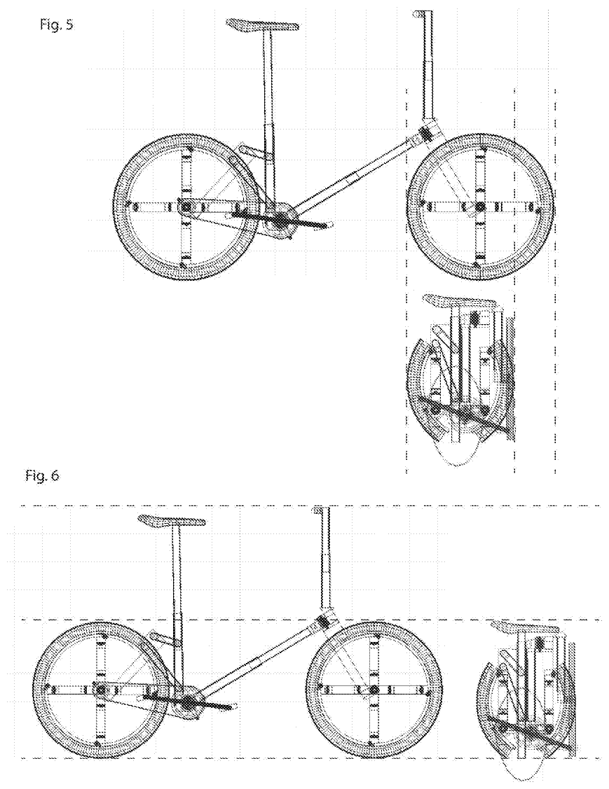

In the FIG. 6, it shown the area relation between the bicycle in its unfold state (left draw) and its fold state (right draw), in this figure we can see that when the bicycle it is in fold state its height it's the same of the unfold wheel.

The bicycle it's conformed mainly by the sections named: rear wheel (24), the front wheel (25), the frame (3) and the handlebar system (1).

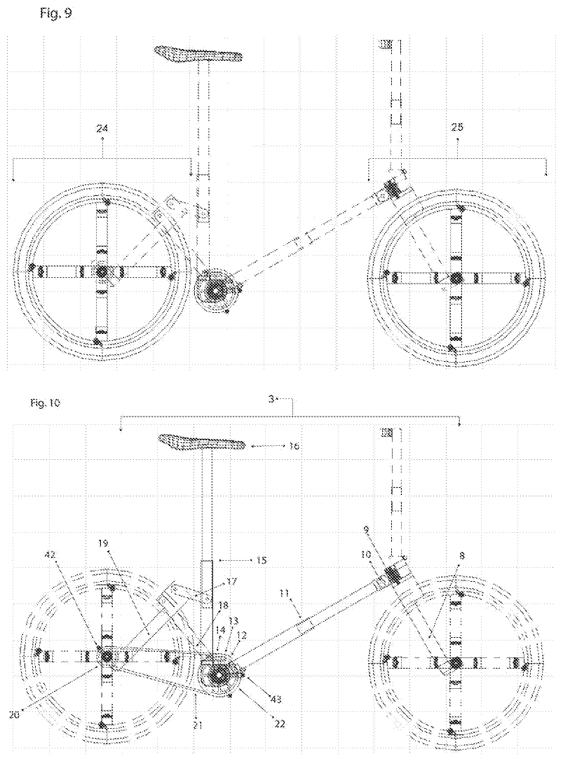

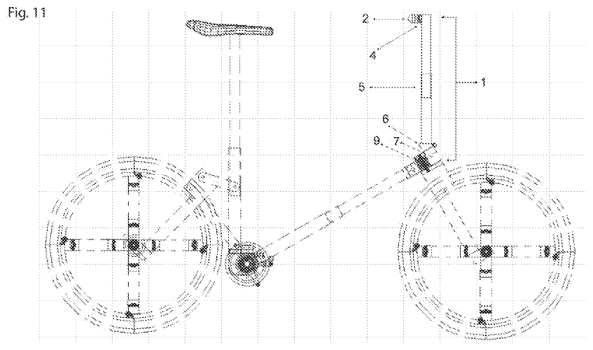

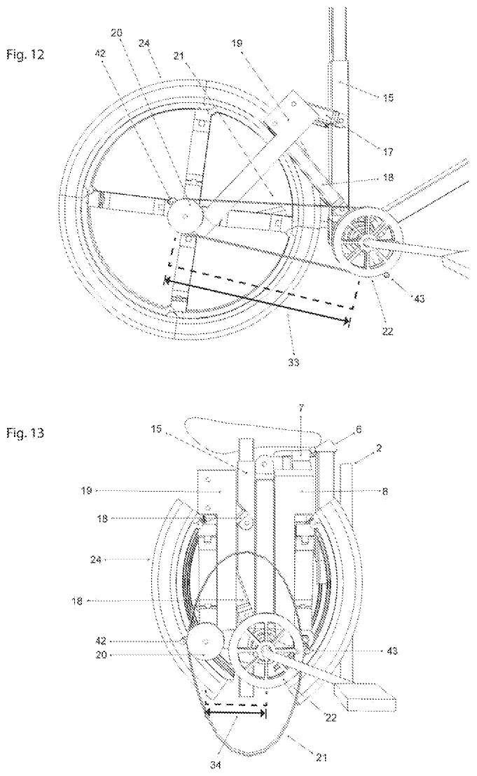

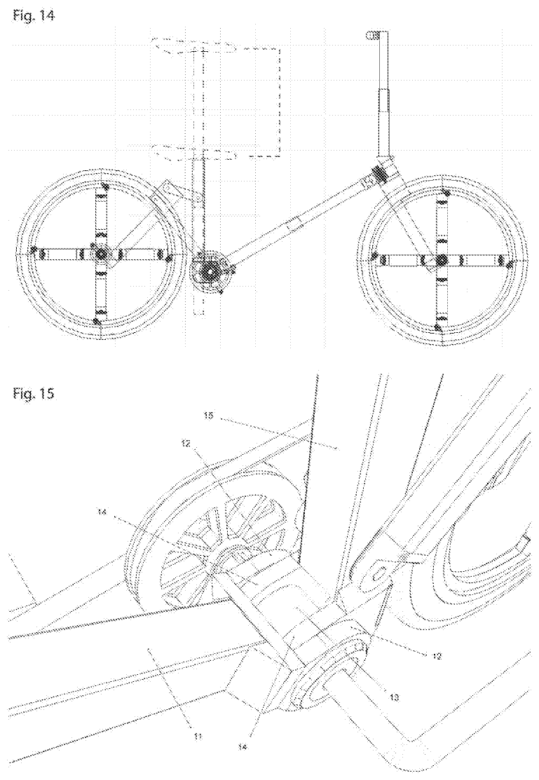

In the FIG. 9, it's shown the rear wheel (24) and the front wheel (25) individually in continuous line, by the wheel arch segment (27), the wheel arch articulation (28), the wheel arch node (29), the wheel articulated arm (30) the wheel axis node (31) and the wheel axis (32).

The wheel unfold and fold process it is achieved first thanks to its discreet segment conformation. This segments known as wheel arch segment (27), allowed that in the unfold state al the segments of the wheel arch segments (27), are aligned in the sagittal plane (35) creating a wheel toroid (26), having the needed structure and tension required to the wheel components work in the ride.

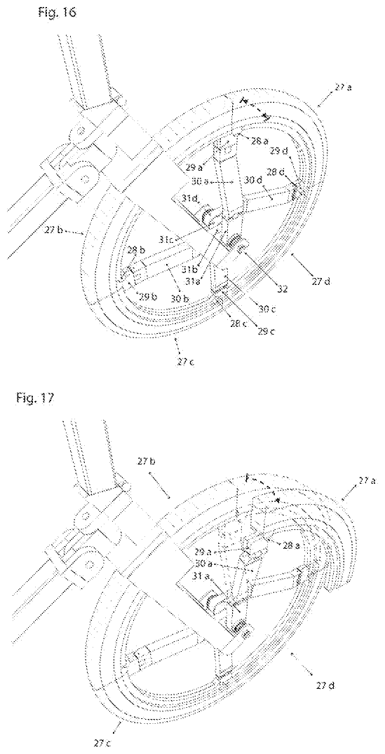

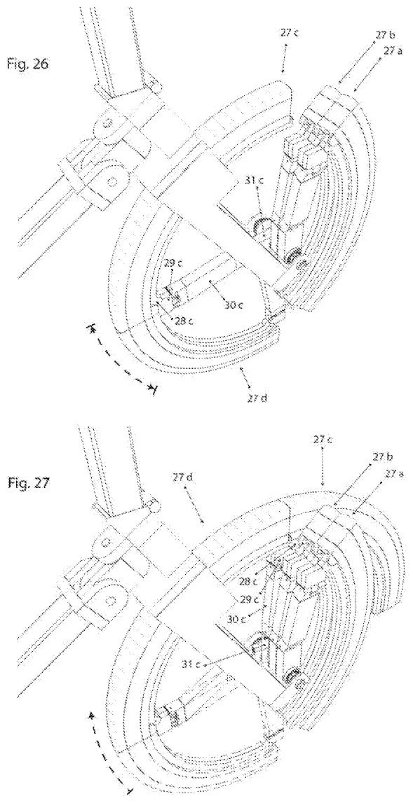

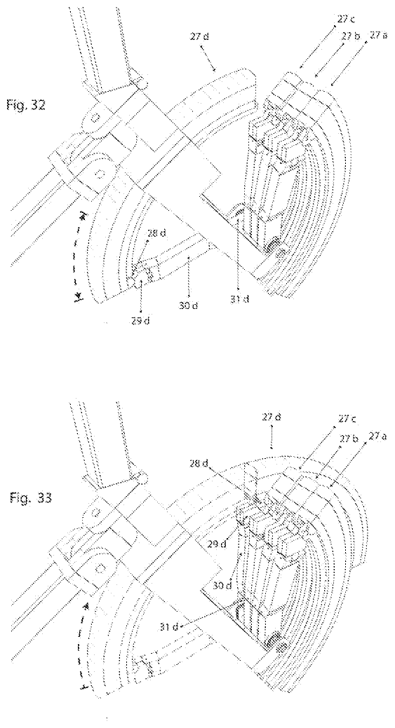

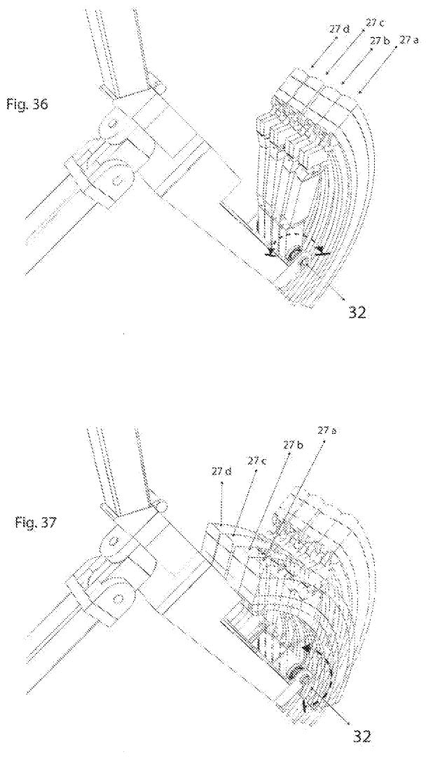

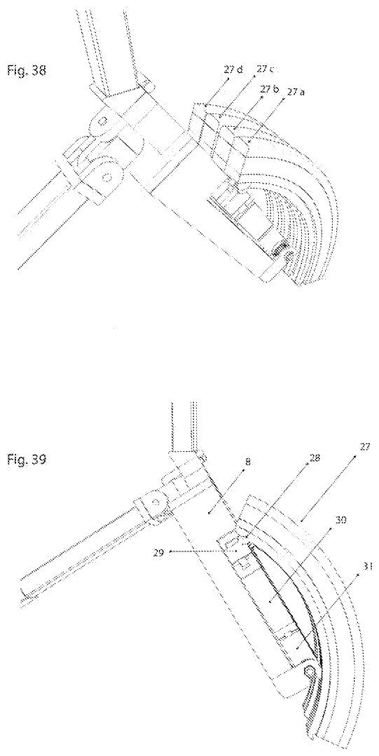

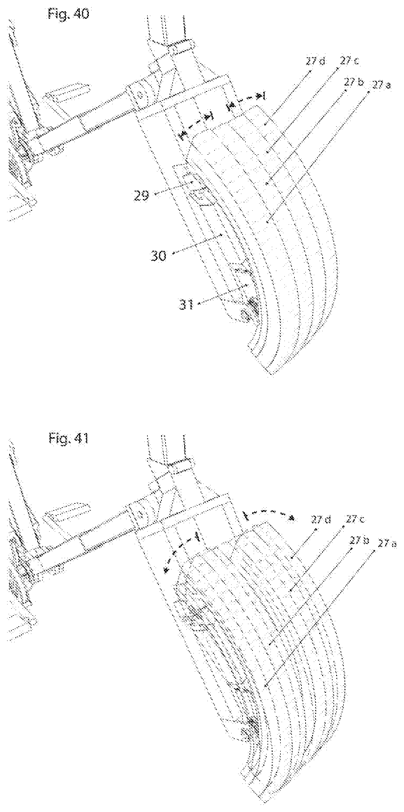

Likewise the wheel toroid (26) conformed by direct segments allows to the combined action of the wheel articulated arm (30) and the wheel axis node (31) displace the wheel arch segments (27) to its fold state as its shown in the FIG. 4 (the wheel fold and unfold process it is detailed describe in the FIG. 16 to FIG. 43).

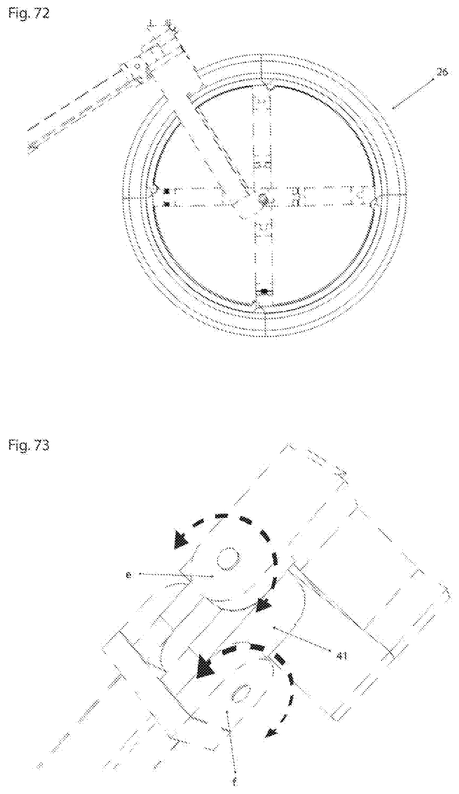

The wheel in its unfold state (24 and 25) the wheel arch segments (27), conformed the wheel toroid (26) referring to the donut shape that it gets with this action, all that's allow the wheel works to the road at its shown in the FIG. 72.

The wheel articulated arm (30) join the wheel arch node (29) with the wheel axis node (31) and supports the compression and tension of the wheels (24 and 25). This compression and tension happens with the bicycle in its unfold state.

The wheel arch segment (27) contains in its structure the running surface (the wheel surface which is in contact with the road)₁, the damping surface (the wheel structure that cushion the ride)₁ and the structural surface (the area that give strength to the whole wheel)₁, needed for a safety and comfortable ride. 1. This clarifications in parenthesis are no present in the spanish original document, because are not needed to defining the surfaces in the wheel. They are added just for clarification purposes and do not add characteristics or any other information.

The wheel hub construction its created by the align of the wheel axis nodes (31), as its shown in the FIG. 75 explosive, this allows the wheel to have two types of rotation.

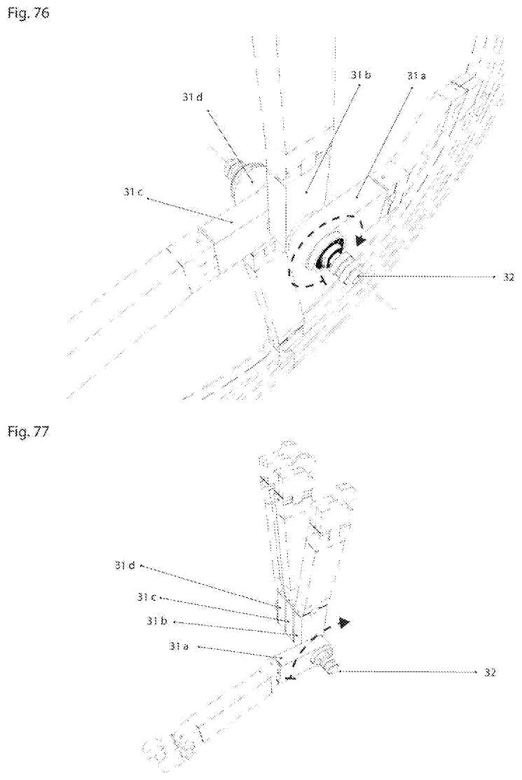

The first rotation type as its shown in the FIG. 76, happens when the wheel are in its unfold state and all the wheel components are integrated to allow the wheel rad rotation.

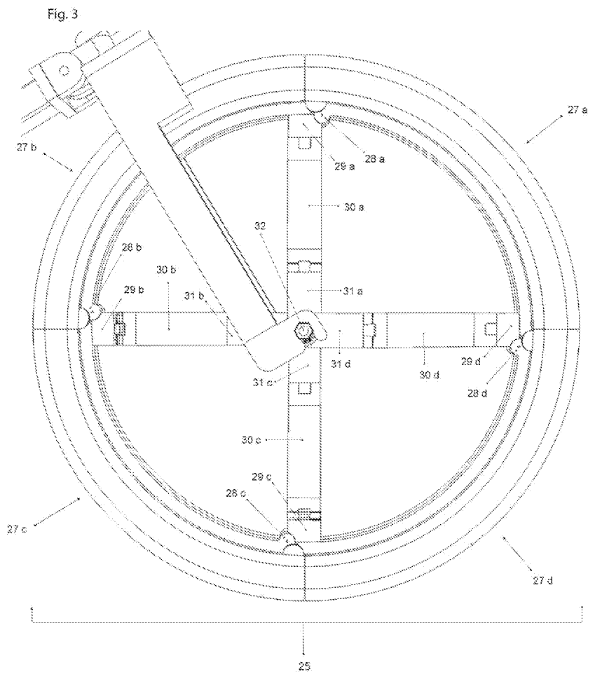

The second rotation type as its shown in the FIG. 77, happened during the wheel fold and unfold process, in which each wheel axis nodes (31), rotate independently to position each one vertically in its fold state as it shown in the FIG. 4, or with the same rotation reach its unfold position like in the FIG. 3.

The wheel arch segments (27) are join to the wheel axis nodes (31) by the wheel articulated arms (30) which allows to change from the wheel fold state to the unfold state and vice versa.

The FIG. 10, show the section frame (3) in continuous line. This section its build by the components that give it the geometry, the structure and the traction to the bicycle when it's in the unfold state.

The joints and extension of this components allow the frame (3) to transit from the fold state to the unfold state and vice versa.

The section of the frame (3) it is divided in the following elements: the rear fork (19), the top seat stays (17), the bottom seat stays (18), the seat post (15), the saddle (16), the bottom bracket (13), bottom joint of the seat post (14), bottom joint of the lower extensible post (12), the power transmission device (21), the front belt-drive (22), front belt-drive lock (43), rear belt-drive (20), the rear belt-drive lock (42), the top joint of the extensible down tube (10), the extensible down tube (11) and the pedals (23).

In the FIG. 11, it show the handlebar system (1), in continuous line which its conformed by the handlebar (2), handlebar joint (4), the handlebar extension system (5), articulated handlebar base (6), handlebar bottom stem (7), steering node joint (9).

The steering node joint (9), allows the rotation in the sagittal plane (35) for the folding process, as in the in the steering of the front wheel in the crossplane (37), when its unfold for the road. In the FIG. 73 it's shown the two types of rotation describe the steering node joint (9).

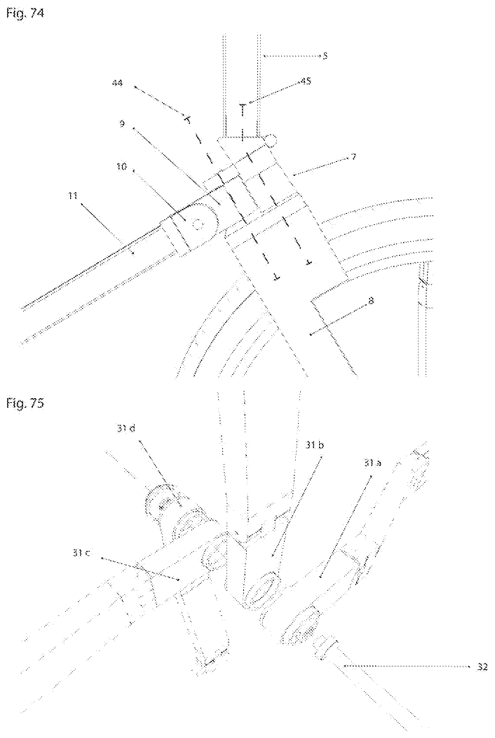

The handlebar axis (45), is the mechanical connection with the handlebar system (1), its which allow the user steering the invention as a transport. The handlebar axis (45) it is eccentric to the steering axis (44), which is the one to allow the rotation of the handlebar system (1) and the front wheel (25). This detail can be observed in the FIG. 74.

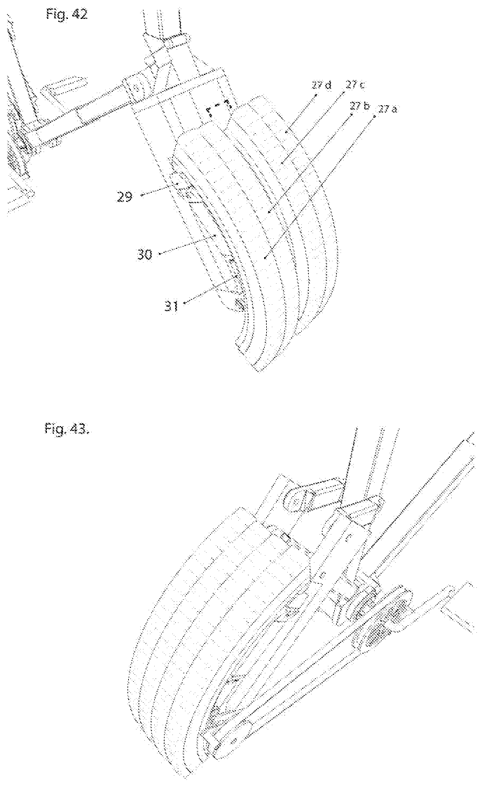

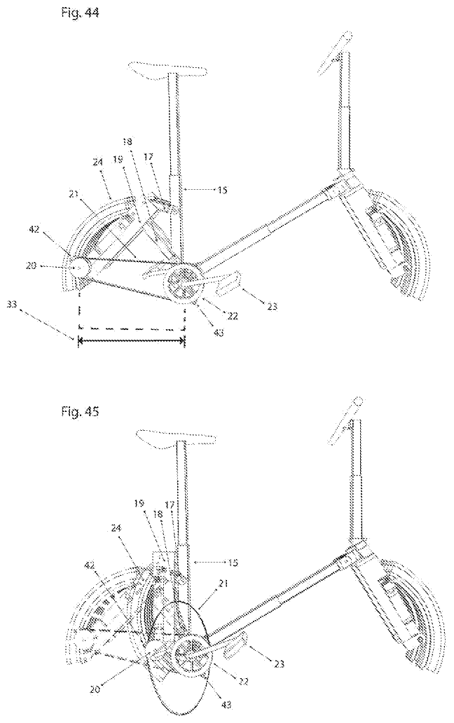

To reduce the folding volume, the handlebar system (1), its storage in the front wheel between the wheel arch segments (27) (b, c) which they create a gap as it shown in the FIG. 42, storing the handlebar vertically in its fold state.

The frame folding happens in the sagittal plane (35) thanks to a series of joints that connect the systems.

The seat post (15), it's a reference of a traditional element of a bicycle, which can be built on a series of geometries like bars, tubes or a combination.

As well the extensible down tube (11), it's a reference of known denomination of this bicycle component, and it can be built on a series of geometries like bars, tubes or a combination.

This folding bicycle invention can be built in its entirety or on individual components using a single material or a combination of material for each element, this material can be metallic alloy, composite materials like fiberglass or carbon fiber, polymers and natural materials like wood, bamboo and leather.

The elements of the bicycle sections; the rear wheel (24), the front wheel (25), the frame (3) and the handlebar system (1), they fold thanks to a series of joints that allows it fold and unfold this elements in next sequence.

Step 1, the folding process as it's shown in the FIG. 17. It displaces the wheel arch segment (27) (a), from is aligned position with the wheel toroid (26) to its fold position. In the FIG. 16 it's shown the range movement of the wheel arch segment (27).

The displacement of the wheel arch segment (27), between their fold and unfold positions it is possible thang to the coordinated action of the wheel articulated arm (30).

The articulation (interior) that joints with the wheel axis node (31) which allow this wheel arch segment (27), displaces form its unfold position (FIG. 3), central of the wheel toroid (26) to its fold position and vice versa.

Also the articulation (exterior) that join the wheel articulated arm (30), with the wheel arch node (29), allowed to the wheel arch segment (27), keep its vertical all the time.

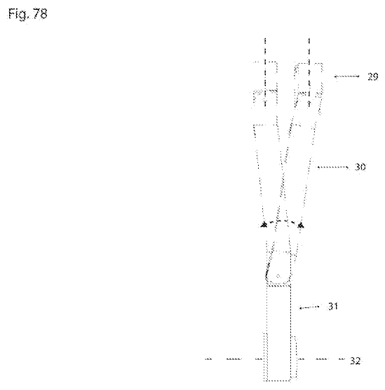

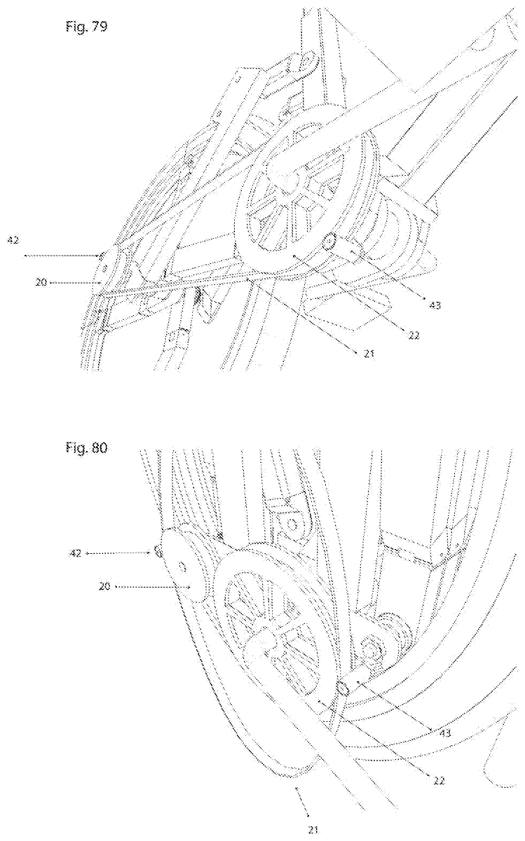

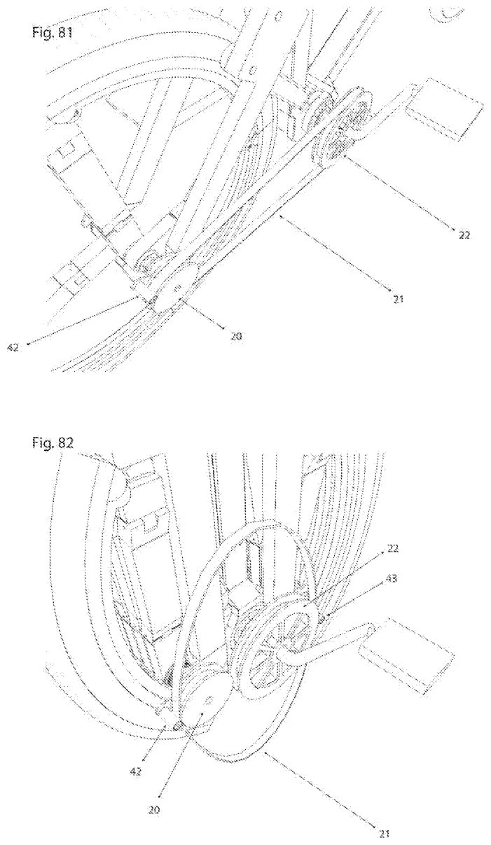

The combined action of the articulations of the wheel articulated arm (30), it is shown in the FIG. 78.

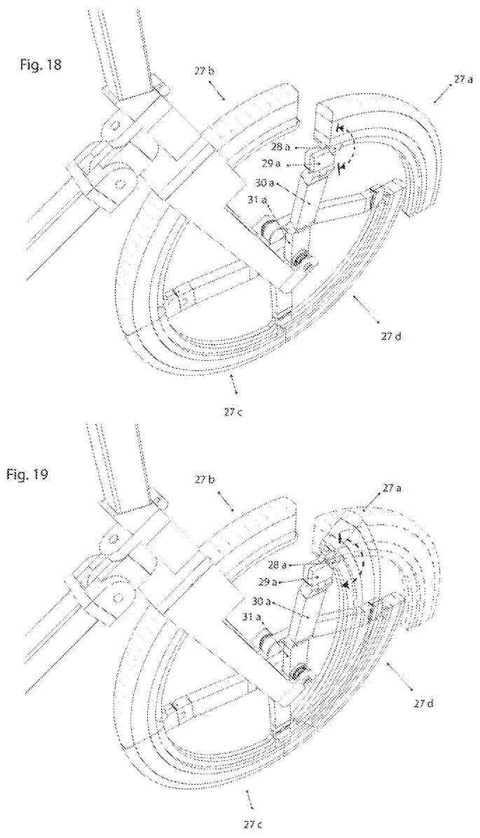

Step 2 of folding as its shown in the FIG. 19, the wheel arch segment (27), make contact with the wheel axis node (31). In the FIG. 18 it shown the rotation range of the articulation of the wheel on the wheel arch segment (27) (a).

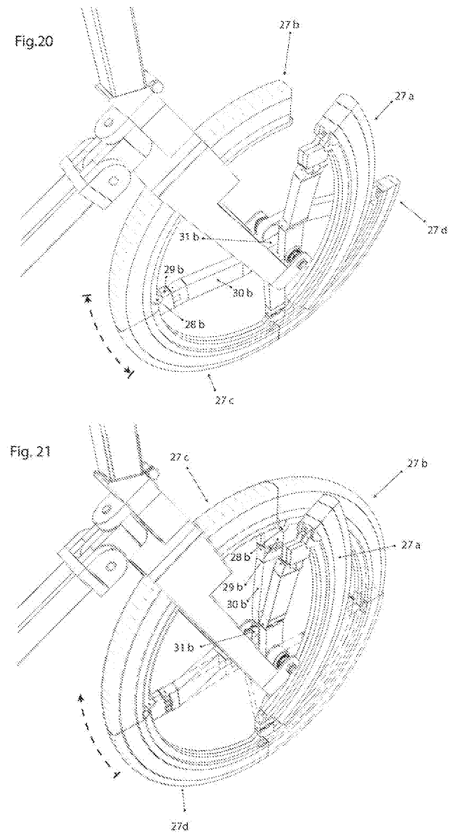

Step 3 of folding as it shown in the FIG. 21 its rotates 90° the wheel toroid (26), composed by the wheel arch segment (27) (b, c, d), align the wheel arch segment (27) (a, b), of the wheel articulated arm (30) which it maintain the same position of the step before. In the FIG. 20 it's shown the rotation range of the wheel arch segment (27) (b, c, d)

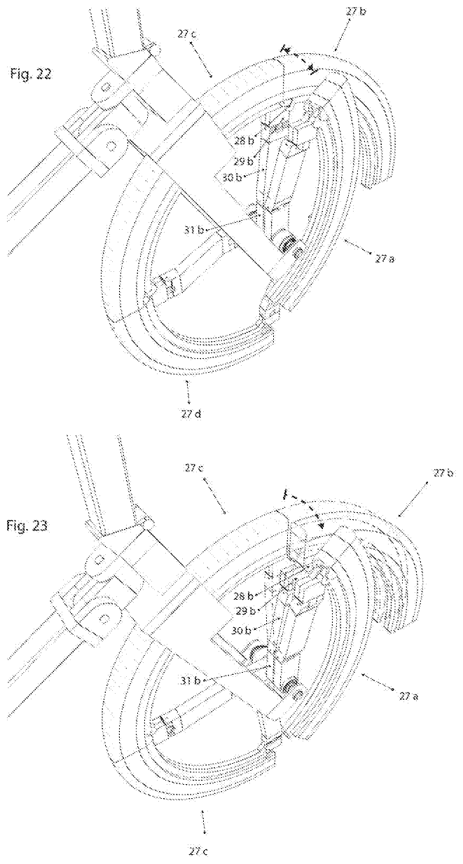

Step 4 of folding as it shown in the FIG. 23, it displaces wheel arch segment (27) (b), it rotates in the cross axis (40), until the interior part of the wheel arch segment (27), make contact with the wheel axis node (31). In the FIG. 22 it showed the movement range of the wheel arch segment (27).

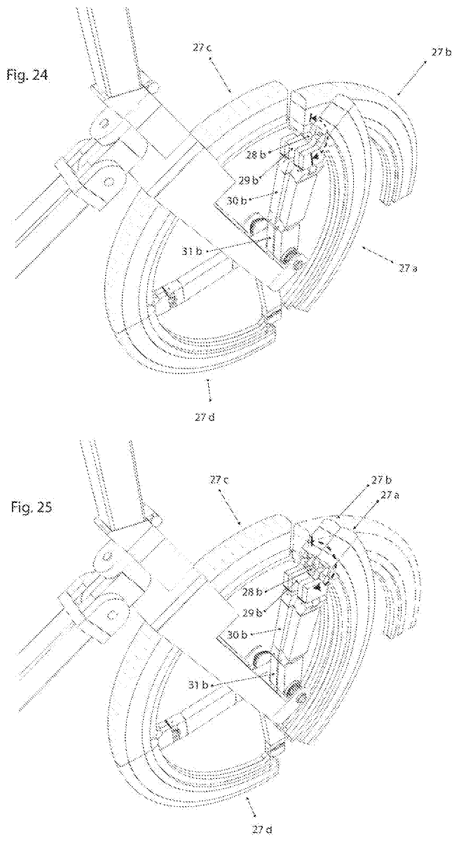

Step 5 of folding as it shown in the FIG. 25, the wheel arch segment (27) (b) it rotates in the cross axis (40), until the interior part of the wheel arch segment (27), make contact with the wheel axis node (31). In the FIG. 24 it showed the movement range of the wheel arch segment (27) (b).

Step 6 of folding as it shown in the FIG. 27 its rotates 90° the wheel toroid (26), composed by the wheel arch segment (27) (c, d), align the wheel arch segment (27) (c), of the wheel articulated arm (30) of the wheel arch segment (27) (b, a) which keeps vertically. In the FIG. 20 it's shown the rotation range of the wheel arch segment (27) (c, d).

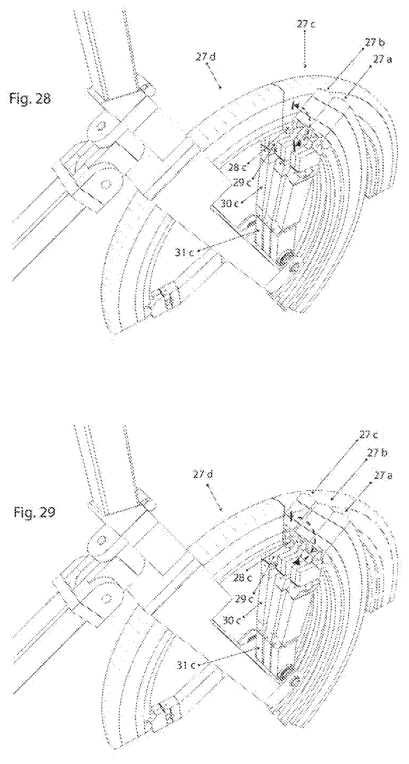

Step 7 of folding as it shown in the FIG. 29, it displaces wheel arch segment (27) (c), it rotates in the cross axis (40), until the interior part of the wheel arch segment (27), make contact with the wheel axis node (31). In the FIG. 28 it showed the movement range of the wheel arch segment (27) (c).

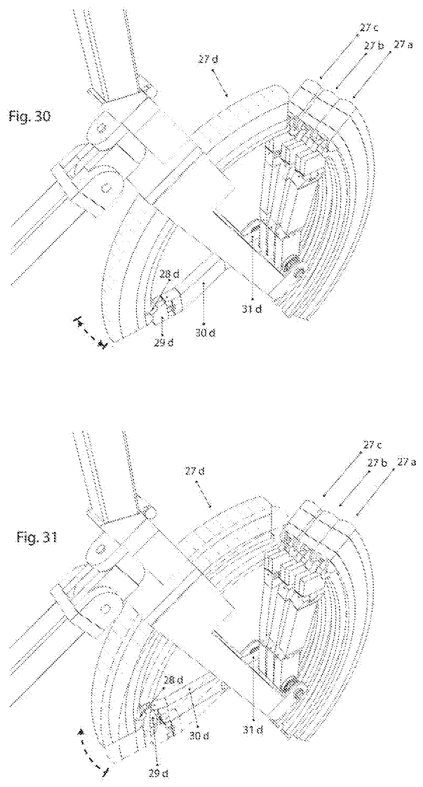

Step 8 of folding as it shown in the FIG. 31, it displaces wheel arch segment (27) (d), from its position align with the wheel toroid (26), to its storage position. In the FIG. 30 it showed the movement range of the wheel arch segment (27) (d).

Step 9 of folding as it shown in the FIG. 33 its rotates 90° the wheel toroid (26), composed by the wheel arch segment (27) (d), align the wheel arch segment (27) (a, b), of the wheel articulated arm (30) which keep vertically FIG. 20 its shown the rotation range of the wheel arch segment (27) (d).

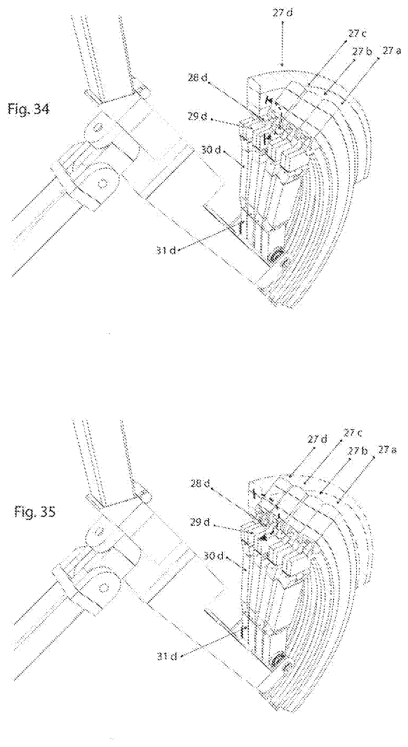

Step 10 of folding as it shown in the FIG. 35, it displaces wheel arch segment (27) (d), it rotates in the cross axis (40), until the interior part of the wheel arch segment (27), make contact with the wheel axis node (31). In the FIG. 34 it showed the movement range of the wheel arch segment (27) (d).

At the end of this step all the wheel arch segment (27), are vertically align.

Step 11 of folding as it shown in the FIG. 37, the set of the wheel arch segment (27), fold it rotates until make contact with its correspondent, been the front fork (8) or the rear fork (19).

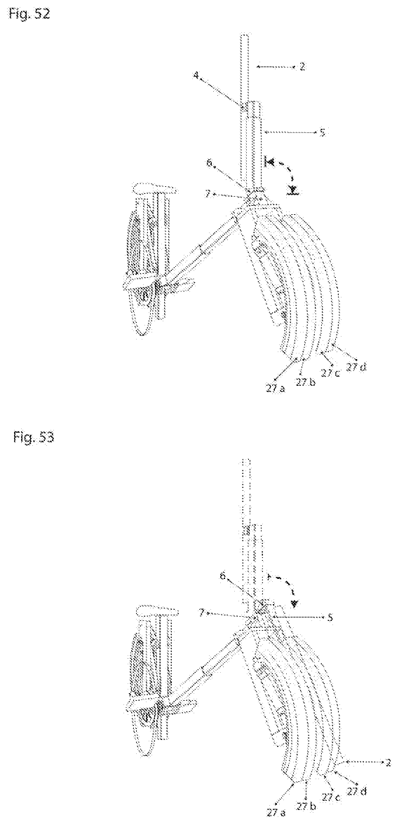

Step 12 of folding as it shown in the FIG. 41, it generate a gap between the sections (b, c). In the FIG. 42 it show the gap created between the arch segment (27) (b, c). The function of this gap it's contain the handlebar system (1) ones its fold as it shown in the FIG. 53, this step its possible only in the front wheel.

For the folding of the rear wheel (24) it's the same procedure until step 11, in which finish the folding process of the rear wheel as it shown in the FIG. 43.

In the FIG. 42 is shown the final result of the folding process of the front wheel (25) and in the FIG. 43, it shown the final result of the folding process of the rear wheel (24).

Step 13 of folding as it shown in the FIG. 45, the rear fork (19) side to the rear wheel (24), it's displaced from its unfold position to its fold position.

This step displacement it's achieved by the combine action of the seat stays. Individually the top seat stays (17) dictates the separation between the ear fork (19) and the seat post (15), meanwhile the bottom seat stays (18) defines the angle of the rear fork (19). This displacement actions are showed in detail in the FIG. 8.

The rear fork (19) in its unfold state as it shown in the FIG. 4, keeps the rear belt-drive (20) away from the front belt-drive (22) to it maximum distance (33), which allows the power transmission device (21) transfer the pedaling power to the rear wheel for movement.

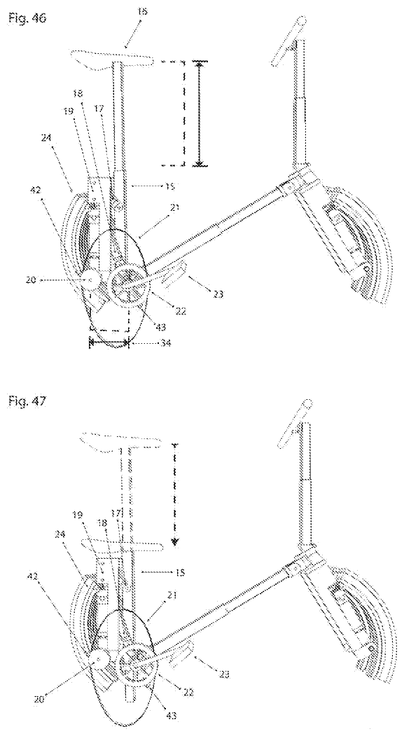

When the rear fork pass to its fold state, the distance between the rear belt-drive (20) and the front belt-drive (22) it reduces to its minimum distance (34) allowing the minimum storing space as it shown in the FIG. 46.

The power transmission device (21), keep its own integrity during the folding and unfolding process, likewise its folding state FIG. 2, thanks it uses a flexible material like a band type.

The power transmission device (21) it stay fixed to the rear belt-drive (20) and to the front belt-drive (22) during the bicycle fold state and the folding and unfolding transitions, thanks to the rear sure of the rear belt-drive lock (42), and the front sure of the front belt-drive lock (43), which avoids that the power transmission device (21) loose contact with rear belt-drive (20) and the front belt-drive (22) in the moment that the power transmission device (21) loose its tension in the fold state as well in the fold and the folding and unfolding transitions. This integrity it cannot be maintained with a metallic chain due the integrity is achieved only by tension, which it is loose in the fold state likewise in the state transitions of this invention.

Step 14 of folding as it shown in the FIG. 47, the saddle (16) transfers for its unfold state to its fold state. In the FIG. 46 it showed displacement range of the saddle.

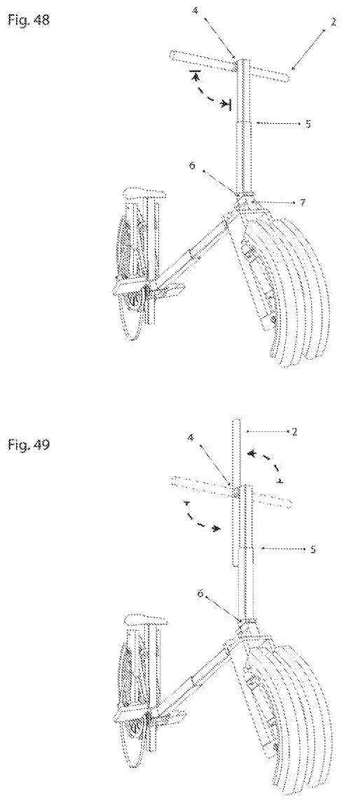

Step 15 of folding as it shown in the FIG. 49, the handlebar (2), it is in its “T” shape in it's unfold state, its turn 90° in the front plane (36). This action allows the handlebar to be vertically aligned with the handlebar extension system (5). In the FIG. 48 it shown the rotation range of the handlebar (2).

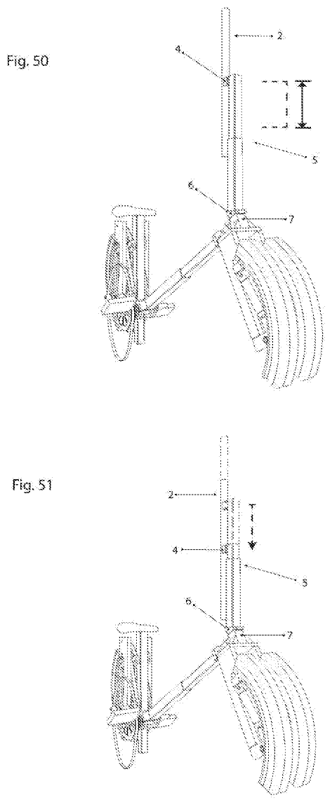

Step 16 of folding as it shown in the FIG. 51, the handlebar extension system transition from it's unfold state, when its retracts to its fold state. In the FIG. 50 it's shown the extension range of the handlebar extension system (5).

Step 17 of folding as it shown in the FIG. 53, the handlebar system (1), its rotate to front in the sagittal plane (35), to being parallel aligned with the front fork (8). The handlebar system (1) it storages in the gap between the wheel arch segment (27) (b, c) of the front wheel of the step 12 which it is shown in the FIG. 41 and FIG. 42. In the FIG. 52, it showed the rotation range of the articulated handlebar base (6).

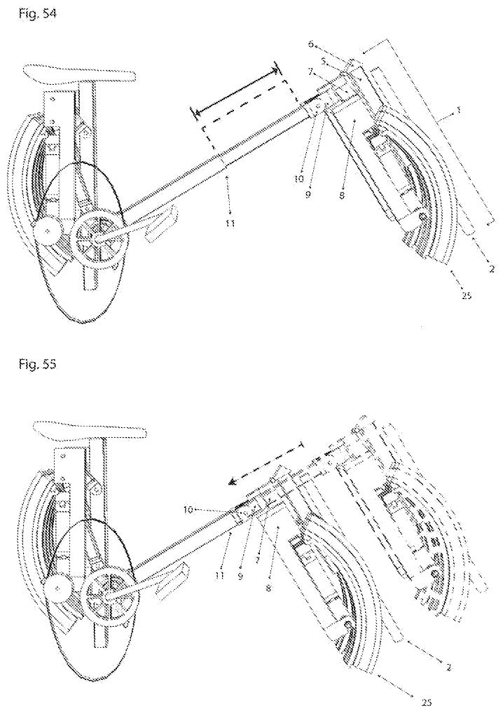

Step 18 of folding as it shown in the FIG. 55, the extensible down tube (11) it reduces it's unfolding maximum extension to the fold state. In the FIG. 54 it showed the extension range of the extensible down tube (11).

Step 19 of folding as it shown in the FIG. 57, the group elements conformed by the steering node joint (9), the handlebar bottom stem (7), the front fork (8), the front wheel (25) and the handlebar system (1), turn thanks to the top joint of the extensible down tube (10) backwards in the sagittal plane (35), to be parallel alignment to the extensible down tube (11). In the FIG. 56 its shown the rotation range.

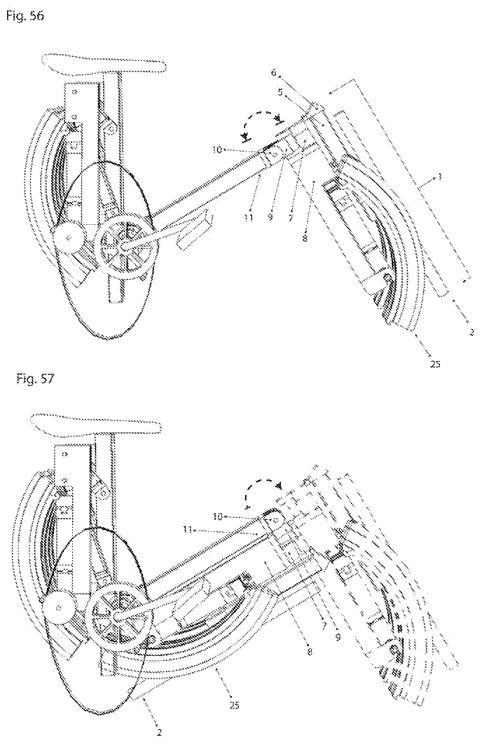

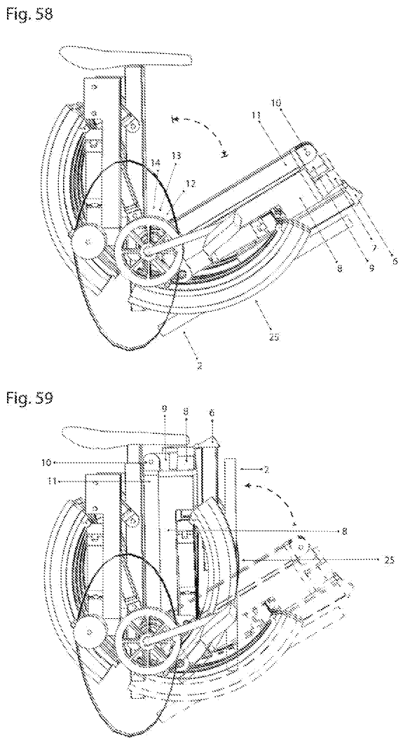

Step 20 of folding as it shown in the FIG. 59 the group elements conformed by the extensible down tube (11), the steering node joint (9), bottom stem (7), front fork (8), front wheel (25) and the handlebar system (1), rotate thanks to the bottom bracket (13), and the combined action of the bottom joint of the seat post (14) and the bottom joint of the lower extensible post (12) like articulation joints, until said group been parallel aligned with the seat post (15), this is shown in the FIG. 15 (In this figure as a reference the front wheel in the left and the left wheel in the right). In the FIG. 58 it shown the rotation range of the elements group.

With the steps sequence mentioned before achieve change the bicycle configuration from it unfold state FIG. 1, to its fold state FIG. 2.

In order to the bicycle can change state from its fold state to its unfold state it is necessary follow the same steps but in reverse order from the step 20 to the step 1.

The folding system of the frame (3), the handlebar system (1), front wheel (25) and the rear wheel (24), allow this invention to have a maximum ratio in its unfold state to a minimum ratio when it's in its fold state, in relation with a human sale as it shown in the FIG. 83.

The systems of the frame (3), the handlebar system (1), the front wheel (25) and the rear wheel (24), allow that the bicycle area in its fold state, will be smaller than the wheel area when it is in its unfold state as it shown in the FIG. 5, that is to say the bicycle size in its fold state it is inferior that the wheel in its unfold state.

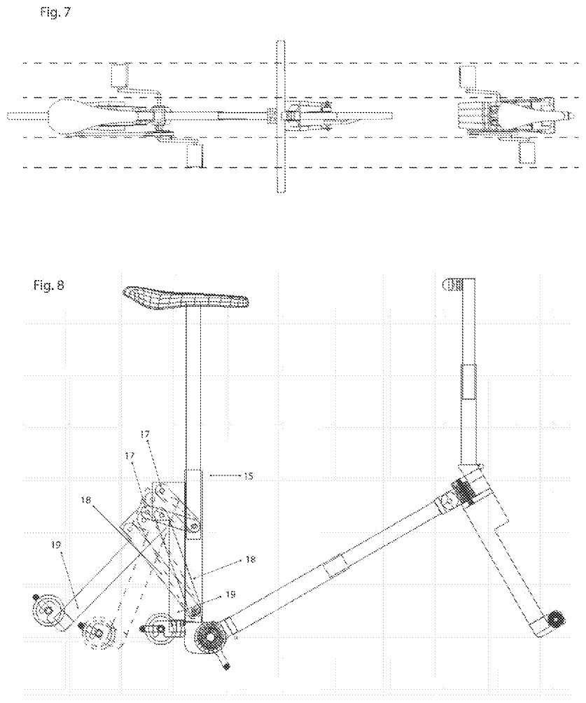

The fact that the fold process mainly happen in the sagittal plane (35), do not increase the bicycle area in its cross axis (40), as it shown in the FIG. 7.

In the bicycle unfold state the front belt-drive (22) and the rear belt-drive (20), keeps the regular distance between them which allow keep the necessary tension to the power transmission device (21), make turn the back wheel to pedaling.

On the other hand in the folding state, the rear fork (19), it displaces that allows it to be aligned with the seat post (15)n as it shown in the FIG. 8, this folding action allows also the front belt-drive (22) and the rear belt-drive (20), facing each other, in the quest of a minimal storage folding state.

Even if this invention has been described in reference to specific details and modalities of itself, it's not intend that details are been considered as limitations of the invention reach, except how as far that are include in the claims that are attached, so that a lot of modifications and variations are possible in referent to the previous description.

### Glossary

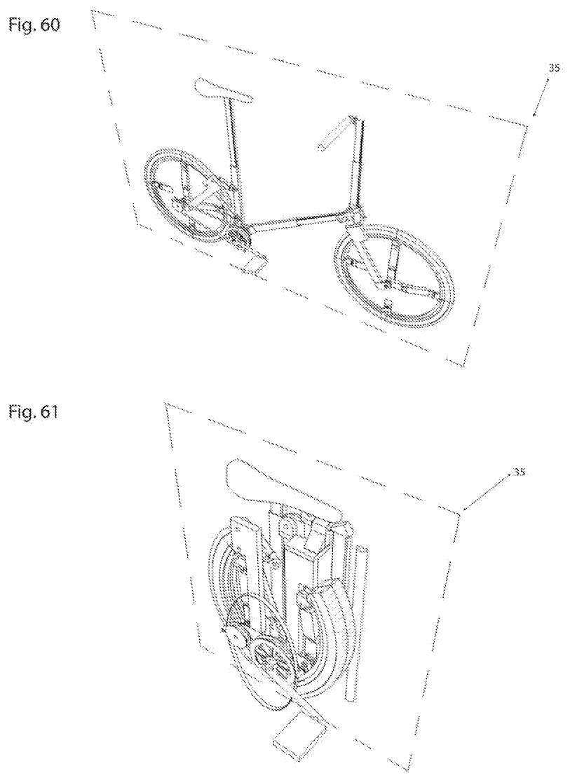

Sagittal plane (35): It is the plane which divide the invention in right and left half which its shown in the FIG. 60 unfold bicycle and FIG. 61 fold bicycle.

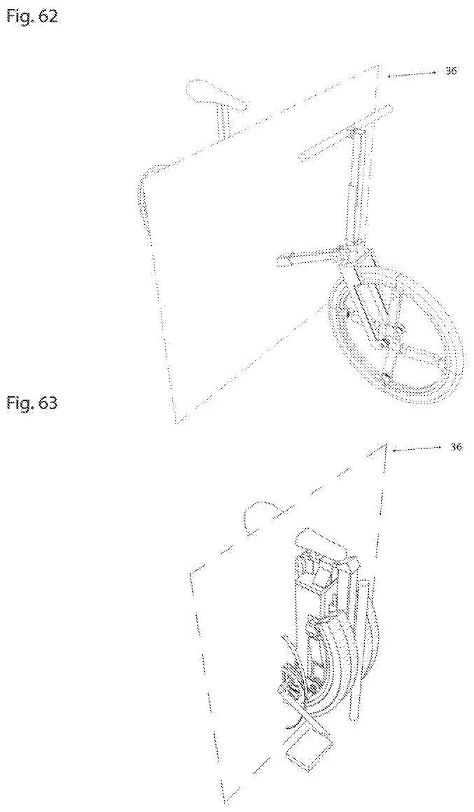

Front plane (36): It is the plane which divides the invention in rear half and front half as it shown in the FIG. 62 unfolding bicycle and FIG. 63 fold bicycle.

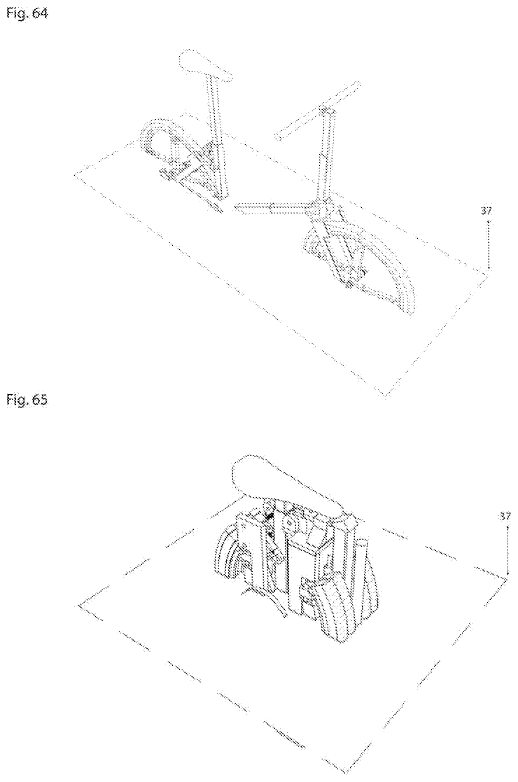

Crossplane (37): It is the plane to divide the invention in an up half and bottom half as it is shown in the FIG. 64 unfold bicycle and Fig. fold bicycle.

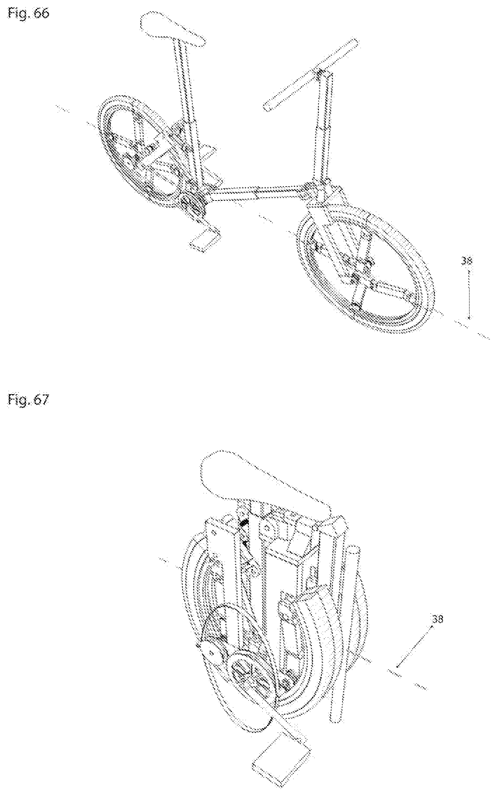

Anteroposterior axis (38): It is the axis that goes from front to back and it is perpendicular to the front plane (36), as it shown in the FIG. 66 unfold bicycle and FIG. 67 fold bicycle.

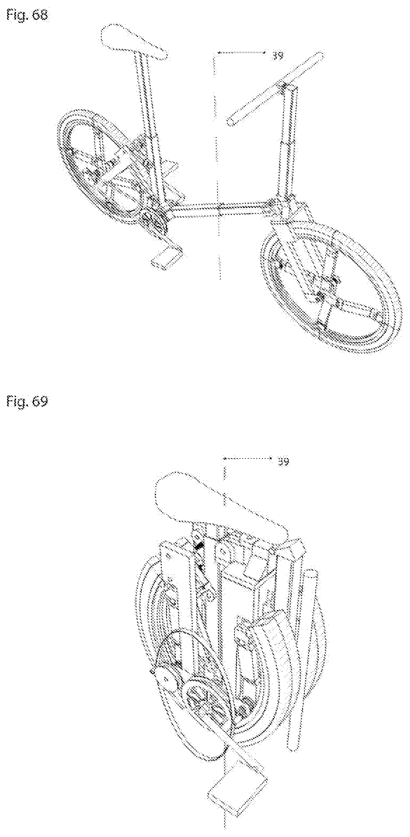

Vertical axis (39): It is the axis that goes from top to down and it is perpendicular to the horizontal plane as its shown in the FIG. 68 unfold bicycle and FIG. 69 fold bicycle.

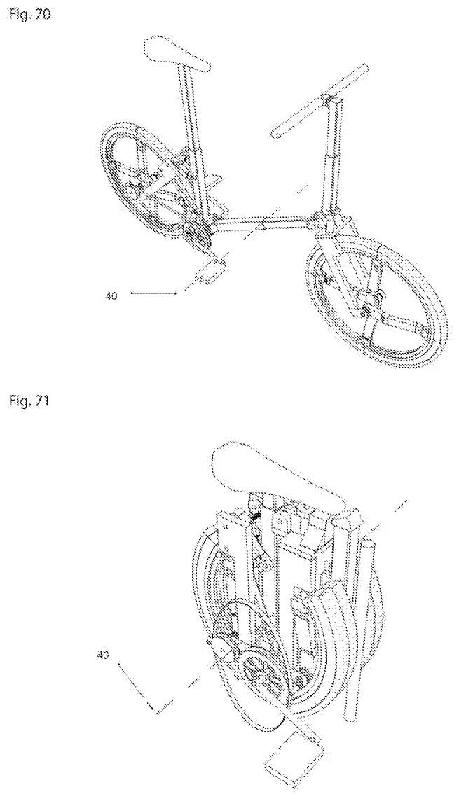

Cross axis (40): It is the axis that goes from side to side and it is perpendicular to the sagittal plane (35), as it is shown in the FIG. 70 unfold bicycle and FIG. 71 fold bicycle.

Wheel toroid (26): It is the toroid geometry (donut shape), which the wheel acquire when it is fully armed or unfold and ready to road, as it shown in the FIG. 72. Equally applied in the front wheel (25) and the rear wheel (24).

Node: It means to a piece that it is the join point of several parts. As example shown in the FIG. 76, the node (41), it works as join point between the pieces (e) and piece (f).

Rotation: It refers to a piece rotation using an axis as rotation center, keeping in a define plane.

Displacement: It is defined by the define distance travel of a particulate piece dictated by a rails, telescopic extension, or joints.

Articulation—Joint: It meant to a connection between two solids witch allow it both move or rotate thanks to the converge in the same axis or fulcrum.

Having described enough my invention, I consider it as a novelty and therefore I claim as my exclusive property, the contained in the followed clauses:

1. Folding bicycle with integral elements and undetachable in its different elements, characterized by they conform by a folding frame (3), a folding handlebar system (1) and folding wheels (24) and (25) which in its whole in its fold state it is inferior to the area of the wheel in its unfold state and where the fold conformation all its elements are vertically aligned.

2. The folding bicycle in accordance with the claim 1 in which the folding frame it is characterized because incorporate the joint system and the folding system of the rear wheel, seat post (15), saddle (16), the bottom bracket (13), bottom joint of the seat post (14), folding power transmission elements and the extensible down tube (11).

3. The folding bicycle in accordance with the claim 2 in where the joint system and the folding system of the rear wheel incorporated rear fork (19), top seat stays (17) and the bottom seat stays (18) which them allow the position displacement of the rear fork to its unfold position to its fold position and vice versa.

4. The folding bicycle in accordance with the claim 2 in which the folding power transmission elements incorporate the power transmission device (21), the front belt-drive (22), the rear belt-drive (20), the rear belt-drive lock (42) and the front belt-drive lock (43), where the power transmission device (21) it is flexible.

5. The folding bicycle in accordance with the claim 2 in which the extensible down tube (11) incorporate the top joint of the extensible down tube (10) and the bottom joint of the lower extensible post (12) where the down tube it is extensible.

6. The folding bicycle in accordance with the claim 2 in which the bottom bracket (13) it is the axis between the bottom joint of the lower extensible post (12) and the bottom joint of the seat post (14).

7. The folding bicycle in accordance with the claim 1 in which the folding handle bar incorporates the handlebar (2), the handlebar stem joint (4), handlebar extension system (5), articulated handlebar base (6), bottom stem (7), steering node joint (9), in where the handlebar on its fold state it stores between the of the wheel arch segment (27) (b, c,) of the front wheel by the rotation action of the articulated handlebar base (6).

8. The folding bicycle in accordance with the claim 7 where the handlebar transit from its “T” shape form its unfold state through a 90° rotation in the frontal plane, to be vertically aligned to the handlebar extension system (5).

9. The folding bicycle in accordance with the claim 7 where the handlebar extension system (5) transit from its unfold state thanks to retracts itself to its fold state.

10. The folding bicycle in accordance with the claim 1 where the rear wheel (24) and the front wheel (25) are characterized because incorporate the wheel arch segment (27) (a, b, c, d), the wheel arch node (29), wheel articulated arm (30), wheel axis node (31).

11. The folding bicycle in accordance with the claim 10 where the wheel arch segment (27), are foldable, allowing the road action, damping and keep structural integrity of the wheel toroid (26).

12. The folding bicycle in accordance with the claim 10 in which wheel arch node (29) keeps the wheel arch segment (27), aligned in its sagittal plane in its fold and unfold state.

13. The folding bicycle in accordance with the claim 10 where the wheel arch node (29) also allow rotate the wheel arch segment (27), from its fold state to its unfold state and vice versa through the wheel arch articulation (28).

14. The folding bicycle in accordance with the claim 10 where the wheel articulated arm (30) join the wheel arch node (29) with the wheel axis node (31) and support the compression and tension of the wheels (24 and 25).

15. The folding bicycle in accordance with the claim 10 where the wheel axis node (31) allow couple and disengage the wheel arch segment (27).

16. The folding bicycle in accordance with the claim 10 in which the wheel axis node (31) allow the rotation of the wheel in its entirety and the independent rotation of the wheel articulated arm (30) in the folding and unfolding process.

17. The folding bicycle in accordance with the claim 10 in which the set of the wheel axis nodes (31), to form the hub wheel.
